(19) United States
(12) Patent Application Publication
(10) Pub. No.: US 2005/0180096 A1
(43) Pub. Date: Aug. 18, 2005

(54) Video structure

(76) Inventor: Shao-Chieh Ting, Taipei City (TW)

Correspondence Address: Shao-Chieh TING, P.O. Box No. 6-57, Junghe,Taipei, 235, TW

(21) Appl. No.: 11/024,911

(22) Filed: Dec. 30, 2004

(30) Foreign Application Priority Data
Feb. 18, 2004 (TW) 093202281

(51) Int. Cl. H02B 1/00; F16M 11/38

(52) U.S. Cl. 361/600

(57) ABSTRACT

A video structure includes a main body, a pivot, and two compartments. A lens assembly is installed inside the main body, which consists of a front cap and a rear cap, constituting two opposite pivoting parts. A holding section is formed between the two pivoting parts for installing the pivot. Pivot pins are extended from two ends of the pivot, passing through the two pivoting parts via the holding section. Two compartments are installed onto the pivot pins at two ends of the pivot outside of the pivoting parts, and a covering piece is extended from the pivot. Two clipping pieces are extended from the two compartments, such that the pivot and the two compartments can be pivoting around the pivoting parts, and the video structure can be clipped onto a screen. On the other hand, an integral body can be formed upon collecting the video structure.

### BACKGROUND OF THE INVENTION

a) Field of the Invention

The present invention relates to a video structure, and more particularly to a video structure which can be quickly clipped onto an LCD screen via the rotation of the video structure itself, and can form an integral body upon being collected.

b) Description of the Prior Art

As a computer has become an indispensably important information product, and the advancement of communication networks, huge amount of information can be quickly accessible via the application of computers. Moreover, as the development of computers evolves into more and more delicate, thinner LCD screens are gradually replacing the screens constituted from an earlier CRT.

However, not only huge amount of information can be accessible by the advancement of computers, but also video conferences can be proceeding, such that users at different places can conduct dialogs directly via a network connection. During the procession of video conferences, video products are the essential electronic products, capturing images and allowing both parties of dialogs to clearly understand each other's reactions and voices.

Conventional video products are required to be emplaced or installed on a platform or a wall independently, which is inconvenient to use. On the other hand, due to the large size of an entire product, more space is required upon usage.

### SUMMARY OF THE INVENTION

Accordingly, the present invention of a video structure comprises primarily a main body, a pivot, and two compartments, wherein a lens assembly is installed inside the main body. The main body consists of a front cap and a rear cap, constituting two opposite pivoting parts, in-between formed a holding section for installing the pivot. Two pivot pins are extended from both ends of the pivot, passing through the two pivoting parts via the holding section, and the two compartments are separately installed onto the pivot pins at two ends of the pivot outside of the two pivoting parts. Moreover, a covering piece is extended from the pivot, and two clipping pieces are extended from the two compartments, respectively. Accordingly, the pivot and the two compartments can pivot around the pivoting parts.

The object of the present invention is to clip the main body onto a screen by the rotation of the compartments and pivot, and to capture images with the lens assembly inside the main body and transmit image information through a network.

Another object of the present invention is to form an integral body upon collecting the video structure.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a schematic view of compartments of the present invention.

FIG. 2 shows a schematic view of the first action of the present invention.

FIG. 3 shows a schematic view of the second action of the present invention.

FIG. 4 shows a schematic view of the profile as shown in FIG. 3.

FIG. 5 shows a schematic view of the implementation of the present invention.

### DETAILED DESCRIPTION OF THE PREFERRED EMBODIMENTS

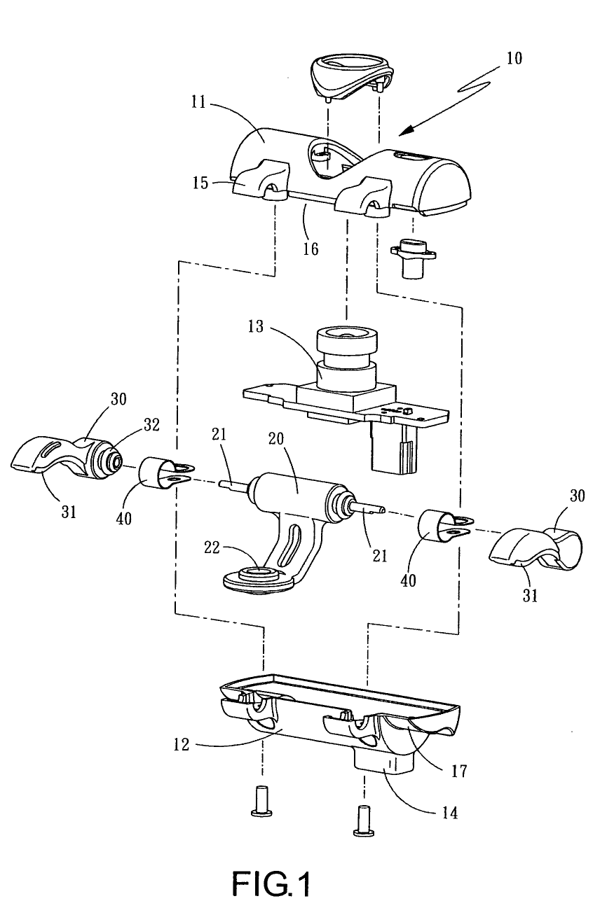

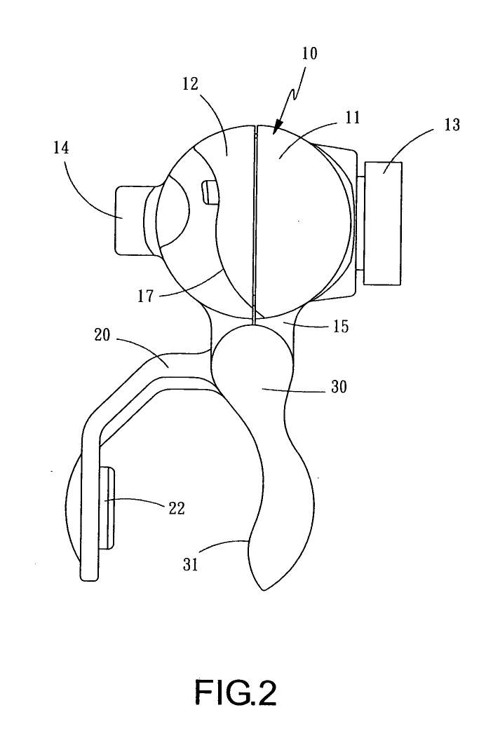

Referring to FIG. 1 and FIG. 2, the present invention of a video structure comprises primarily a main body 10, a pivot 20, and two compartments 30, wherein the main body 10 consists of a front cap 11 and a rear cap 12. A lens assembly 13 is located inside the main body 10, and protruded out of the main body 10, with a connecting port 14 at the outside of the main body 10. Two opposite pivoting parts 15 are constituted after combining the front cap 11 and the rear cap 12, and a holding section 16 is formed between the two pivoting parts 15. Moreover, corresponding holding parts 17 are located at two outer sides of the main body.

The pivot 20 is located inside the holding section 16, and pivot pins 21 are extended from two sides of the pivot 20, passing through the two pivoting parts 15, respectively, thereby rotating the pivot 20 via the pivoting parts 15. Moreover, a covering piece 22 is extended from the pivot 20.

The two compartments 30 are separately installed onto the pivot pins 21 of the pivot 20 outside of the pivoting parts 15, and can simultaneously rotate via the pivot pins 21. Two clipping pieces 31 are separately extended from the compartments 30, and are opposite to the holding parts 17 at two outer ends of the main body 10, thereby constituting the rear cap into an integral body.

Accordingly, the pivot 20 and two compartments 30 can pivot around the pivoting parts 15 of the main body 10, upon installing the pivot 20 and compartments 30 onto the main body 10.

Moreover, two spring leaves 40 are separately installed between the two compartments 30 and the pivot pins 21, and soft gaskets 32 are installed at the ends of compartments 30 opposite to the pivot pins 21. The two soft gaskets 32 are emplaced inside the spring leaves 40, and are combined tightly, such that when the pivot 20 and the two compartments 30 pivot around the pivoting parts 15 of the main body, the damping force resulting from the soft gaskets 32 and the spring leaves 40 can maintain the adequate clipping force for the covering piece 22 on the pivot 20 and the two compartments 30, and can adjust the elevation angle of the lens and the angle of the clipping pieces.

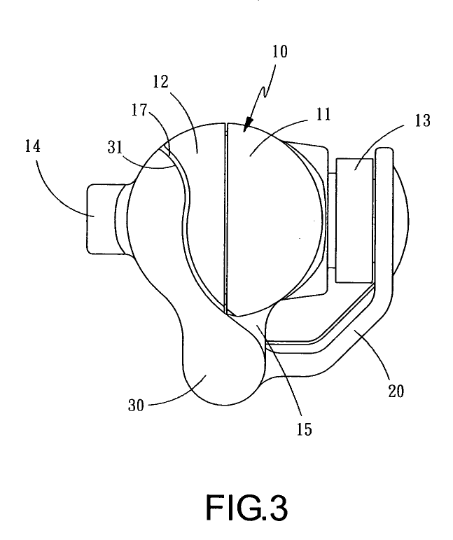

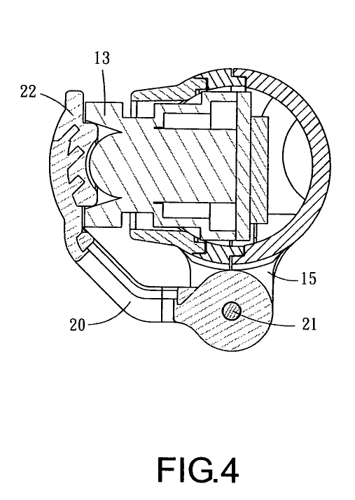

Referring to FIG. 3 and FIG. 4, when the pivot 20 and the two compartments 30 pivot around the pivoting parts 15, the covering piece 22 on the pivot 20 can be covered on the lens assembly 13 protruded out of the main body 10, thereby protecting the lens assembly 13.

The holding parts 17 are installed at two outer sides of the main body 10 relative to the clipping pieces 31 of the two compartments 30, such that the clipping pieces 31 of the two compartments 30 and the holding parts 17 can be mutually corresponding, thereby emplacing the two compartments 17 on the holding parts 17, respectively, and constituting an integral body with the main body 10.

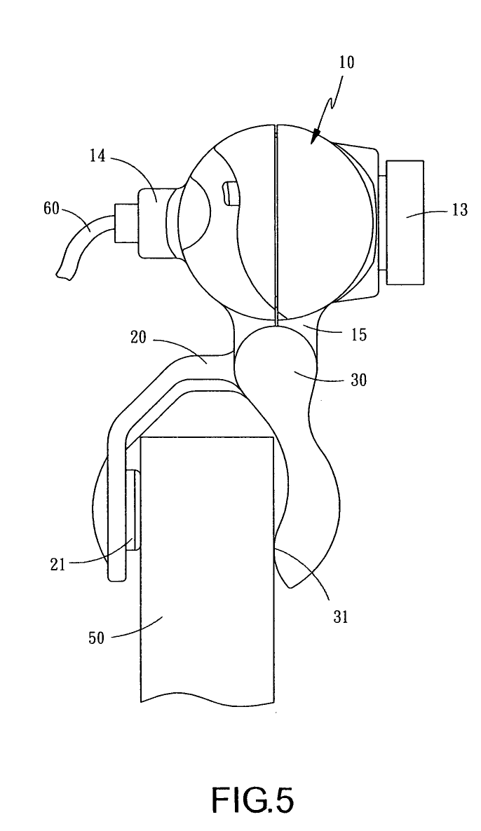

Referring to FIG. 1 and FIG. 5, upon installing the video structure onto a screen 50, the pivot 20 and the two compartments 30 can pivot around the pivoting parts 15 of the main body 10, constituting an effect of mutual clipping among the pivot 20, the covering piece 22 on the two compartments 30, and the clipping pieces 31, and maintaining the clipping force between the covering piece 22 and the clipping pieces 31 by restoring force of the spring leaves 40, such that the main body 10 can be clipped onto the screen 50, and the lens assembly 13 inside the main body 10 can be connected with a computer with a connecting wire 60 at the connecting port 14, in order to capture images through the lens assembly 13 on the main body 10, and transmit to the computer via the connecting wire 60, and then transmit through a communication network, thereby proceeding video conferences or communication.

Accordingly, as shown in all the figures, in the present invention of a video structure, the pivot 20 and the two compartments 30 can pivot around the pivoting parts 15 on the main body 10, such that an effect of mutual clipping can be formed among the pivot 20, the covering piece 22 on the two compartments 30, and the clipping pieces 31, and clip the video structure onto the screen 50 with the covering piece 31 and the clipping pieces 31, to achieve the function of quick clipping. On the other hand, the video structure can be connected with a computer via the connecting wire 60 of the connecting port 14 on the main body 10, and images captured by the lens assembly 13 inside the main body 10 can be transmitted to the computer via the connecting wire 60, and then can transmitted concurrently via a communication network.

It is of course to be understood that the embodiments described herein is merely illustrative of the principles of the invention and that a wide variety of modifications thereto may be effected by persons skilled in the art without departing from the spirit and scope of the invention as set forth in the following claims.

1. A video structure comprising a main body, and a lens assembly therein, which is protruded out of the main body, with two opposite pivoting parts on the main body, constituting a holding section, and two corresponding holding parts installed at two outer sides of the main body; a pivot installed in the holding section, with pivot pins extended from both ends, passing through the pivoting parts, and a covering piece extended from the pivot; two compartments separately installed onto the pivot pins outside of the pivoting parts, with clipping pieces extended from the compartments relative to the holding parts at two outer sides of the main body; having the characteristics that spring leaves are located between the two compartments and pivot pins, to maintain adequate restoring force on the pivot pins for the two compartments, and soft gaskets are located at two ends of the compartments relative to the pivot pins, which are combined tightly and installed inside the spring leaves, resulting in damping force with the spring leaves, such that the pivot and the two compartments can pivot around the pivoting parts of the main body, the covering piece on the pivot can be covered on the lens assembly, and the two compartments can be installed onto the holding parts at two outer sides of the main body to constitute an integral body.

2. The video structure according to claim 1, wherein a connecting port is located outside of the main body, and a connecting wire is used to connect the lens assembly with a computer.

3. The video structure according to claim 1, wherein the main body is constituted from a front cap and a rear cap.
